(19) United States
(12) Patent Application Publication
(10) Pub. No.: US 2021/0347306 A1
(43) Pub. Date: Nov. 11, 2021

(54) TAILGATE, DOOR, AND REMOVABLE TOP WITH STORAGE

(71) Applicant: Mitch P. Walk, Temecula, CA (US)

(72) Inventor: Mitch P. Walk, Temecula, CA (US)

(21) Appl. No.: 17/313,714

(22) Filed: May 6, 2021

Related U.S. Application Data
(60) Provisional application No. 63/020,822, filed on May 6, 2020.

(51) Int. Cl. B60R 7/04

(52) U.S. Cl. CPC B60R 7/046

(57) ABSTRACT

A modular storage solution for vehicular tailgates, doors, and removable tops is provided. The tailgate, door, or top includes a base, a mounting system on the outside of the base and/or a cavity within the base, both to be used for storage and containment solutions.

### FIELD OF THE DISCLOSURE

The present invention generally relates to vehicular tailgates, doors, and removable tops having stand-alone storage capacity.

### BACKGROUND

Currently, there is a lack of beneficial storage areas and mounting systems for vehicles with tailgates, doors, and removable tops. The only options available to date either require modifications, such as aftermarket fabric and metal attachments with PALS/MOLLE system capabilities or bulky, universal storage bins that are not specifically made to fit the areas in which they are placed. The modularity of tailgates currently only applies to optional assist steps, table top fold-outs, and bed extensions. Typically, doors are limited to internal storage by utilizing pockets on the inside of the vehicle; rarely, aftermarket fabric and webbing pieces are attached around the outer portion of aftermarket tube doors. Removable tops are not currently made with any storage capabilities. The small number of available options fails to keep items secure at all times and also fails to take advantage of all available space on the vehicle. The lack of security and efficient utilization of available space can lead to stolen or lost items, disorganization, multiple necessary trips to carry everything, and loose items in a vehicle or other area.

### BRIEF DESCRIPTION OF THE DRAWINGS

FIG. 1 is a perspective view of a tailgate including an internal storage drawer.

FIG. 2a is a perspective view of a fold-down tailgate with multiple exemplary mounting points

FIG. 2b is a perspective view of a swing-out tailgate with multiple exemplary mounting points.

FIG. 3 is a perspective view of the front (towards cab) of the tailgate of FIG. 1 accessorized with multiple items, including a mounting rack that is MOLLE compatible and a MOLLE panel.

FIG. 4 is a perspective view of a tailgate with accessories coupled thereto. Specifically, there is a fuel can mount attached to the tailgate as well as brackets made to mount to the accessory holes in the tailgate.

FIG. 5 is a front-facing perspective view of a tailgate with mounting points and provisions for integrated floodlights or spotlights.

FIG. 6 is a perspective view of the top of an exemplary tailgate with modular attachment points, holes for inserting mounts, and openings for lights.

FIG. 7 is a perspective view of a tailgate with a removable panel.

FIG. 8 is a view of FIG. 7 with the panel removed to show an optional cavity for storage.

FIG. 9 is a perspective view of the front-facing portion of a tailgate shown in FIG. 8 with an attached panel that has built-in cup holders, a MOLLE panel system for storage, and a 110v outlet.

Corresponding reference characters indicate corresponding parts throughout the drawings.

### DETAILED DESCRIPTION OF THE INVENTION

The present disclosure relates generally to tailgates, doors (side doors, lift gates, trunks, etc.), and removable tops, and more specifically to vehicular tailgates, doors, and tops, each of which has the capability of providing stand-alone storage capacity, both internally and externally. There is a need to easily and cost-effectively provide additional storage, mounting options and security options for tailgates, doors, and removable tops in vehicles and trailers. The tailgates, doors, and tops include provisions for modular attachments including, but not limited to, gas cans, tools, batteries, gear bags, ladders, bike racks, tailgate protectors, storage containers, shelving, roof racks, tents, lights, extensions, hooks, etc. Storage capacity can be incorporated via numerous applications, including, but not limited to, drawers and doors that can optionally be locked into position when the tailgate or door is closed (depending on size and placement), provisions for attaching storage devices and other items, and the PALS/MOLLE attachment system. These are aided by the additional options of fabricating the tailgates and/or doors to work as either fold down, swing-out, or both, depending on the user's desire, as well as optional provisions for gas lift struts to assist with safely raising and lowering the tailgates and doors. This utility will work on many vehicles and vehicular components including, but not limited to trucks, cars, SUVs, UTVs, tractors, and trailers.

Exemplary embodiments of tailgates, doors, and removable tops with storage capacities are described herein. The systems are not limited to the specific embodiments described herein, but rather, components of systems that may be utilized independently and separately from other components described herein. One advantage of the systems and methods described herein is that a tailgate, door or top is not limited to a particular storage option provided by the vehicle manufacturer but rather provides a user the flexibility of quickly removing and/or adding modular accessories and/or storage that are chosen for a particular trip or secured location.

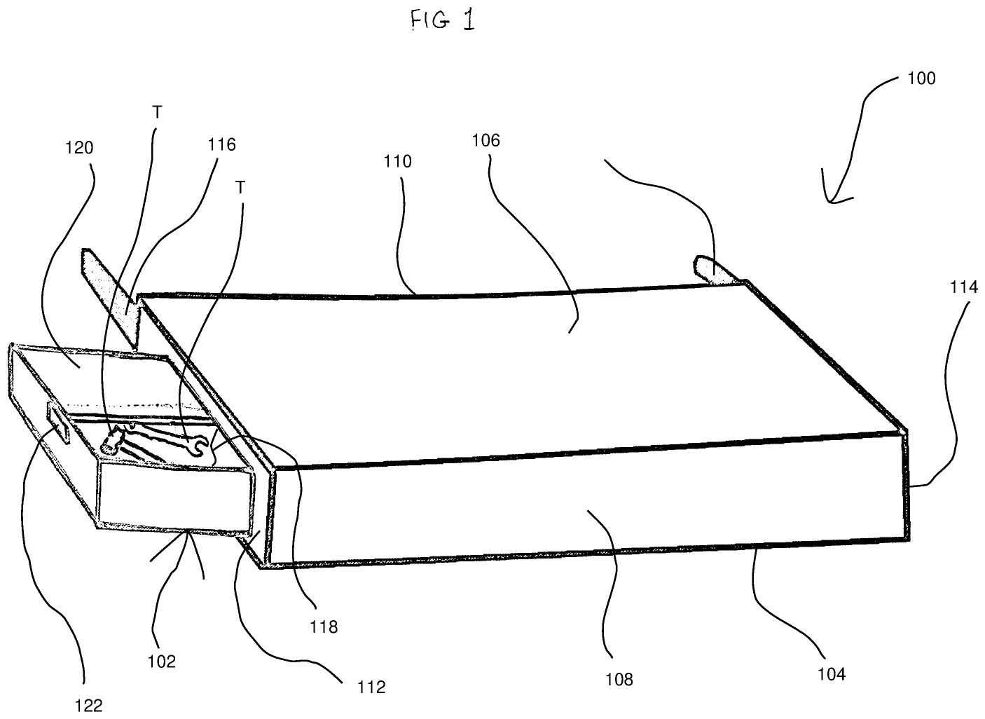

Referring to FIG. 1, the tailgates, doors, and removable tops (generally, door 100) can include an internal storage drawer (generally, drawer 102). The door 100 has a front side 104, a back side 106, a top 108, a bottom 110, a left side 112, a right side 114, and attachment members 116. The attachment members 116 attach the door 100 to a vehicle. The internal storage drawer 102 comprises a cavity 118 in which various tools T can be stored, a retention member 120, and a handle 122. The retention member 120 is configured to further define the cavity 118 and prevent the tools stored inside of the cavity from creating a drawer jam. A drawer jam may be created when the door is in the upright position and the vehicle is driven on a road, causing the tools to move around in the drawer. The retention member prevents this by confining the tools into an enclosed area within the cavity 118. In the illustrated embodiment, the drawer 102 is configured to come out of the left side 112 of the door 100. The drawer 102 can be mounted using a ball bearing drawer slide, bottom mount drawer slide, side mount drawer slide, or center mount drawer slide.

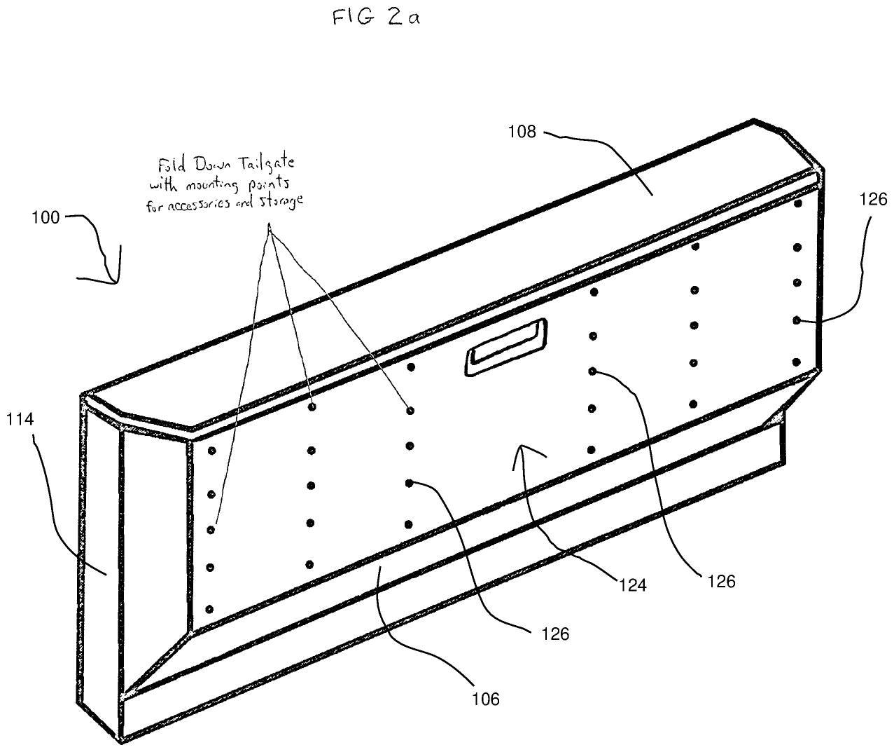

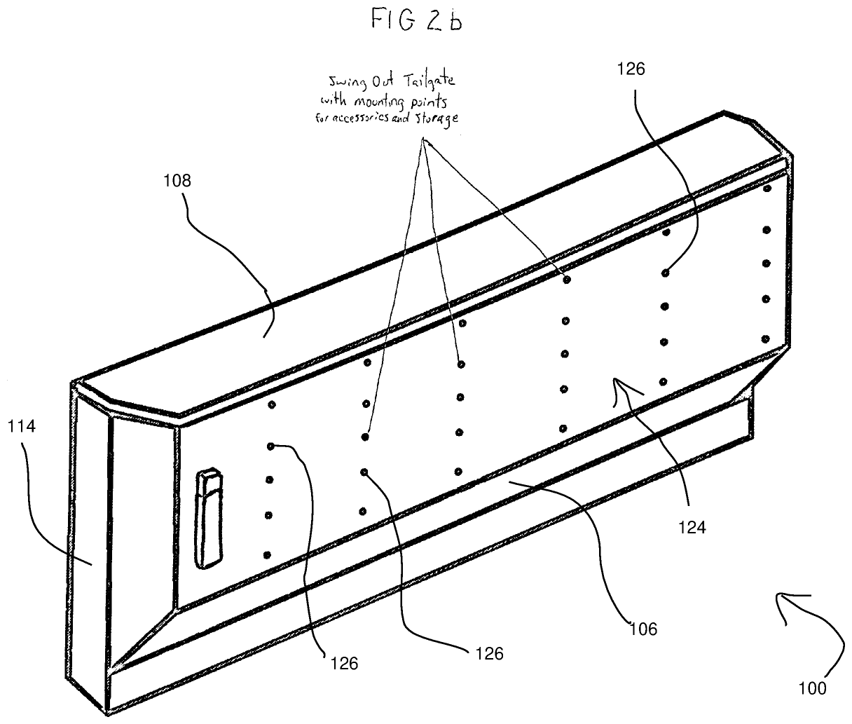

Referring to FIGS. 2a and 2b, the door 100 includes mounting board 124 with multiple mounting points 126 for accessories and storage. In one configuration, the mounting board 124 is configured to be a peg board-type board, in which hooks or pegs can be inserted.

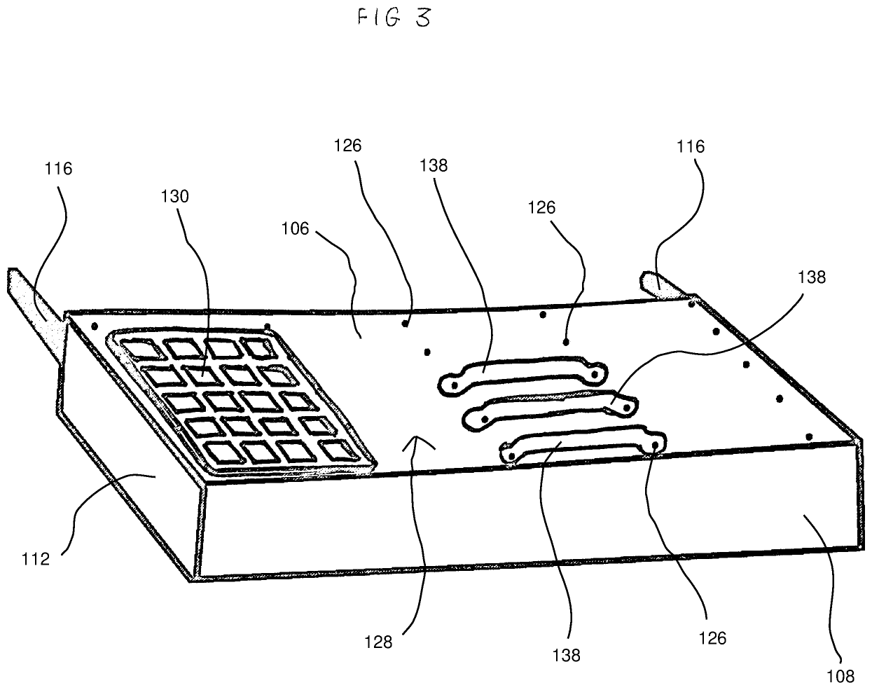

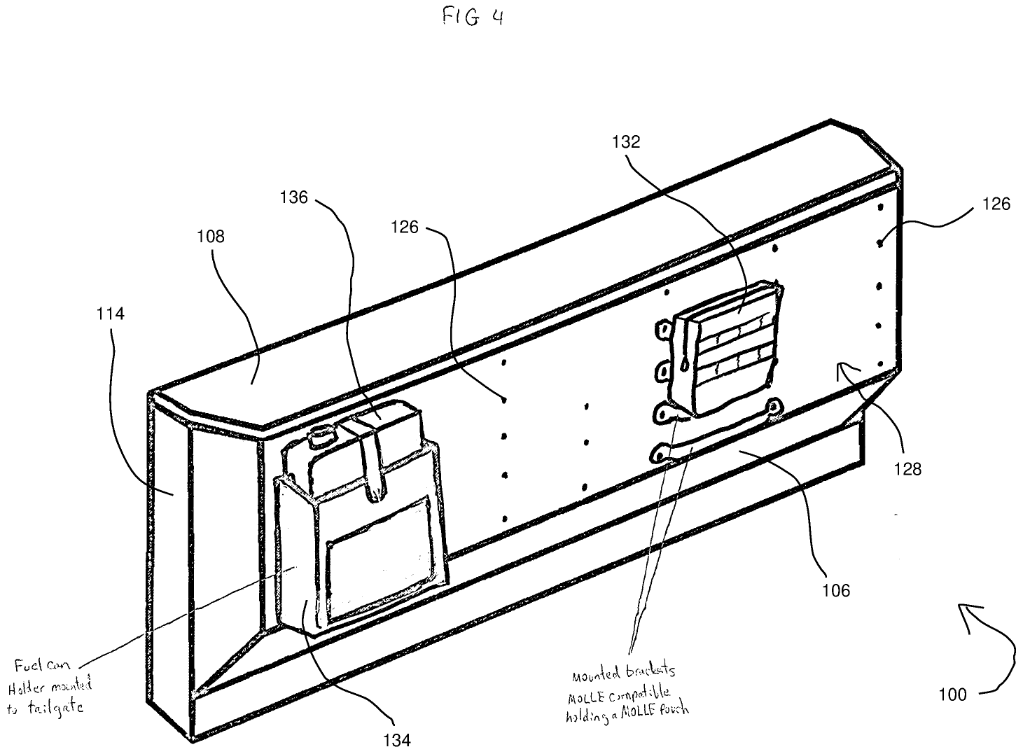

Referring to FIGS. 3 and 4, the door 100 includes PALS/MOLLE compatible accessories, for example, a MOLLE compatible mounting rack 128 and/or MOLLE panel 130. The mounting rack 128 is configured to include mounting points 126 to attach brackets 138 to the mounting rack. As shown in FIG. 4, the MOLLE rack 128 or panel 130 can be used to mount a variety of accessories, for example a MOLLE pouch 132 or other type of holder (e.g., the fuel can holder 134 for holding a fuel can 136 as seen in FIG. 4).

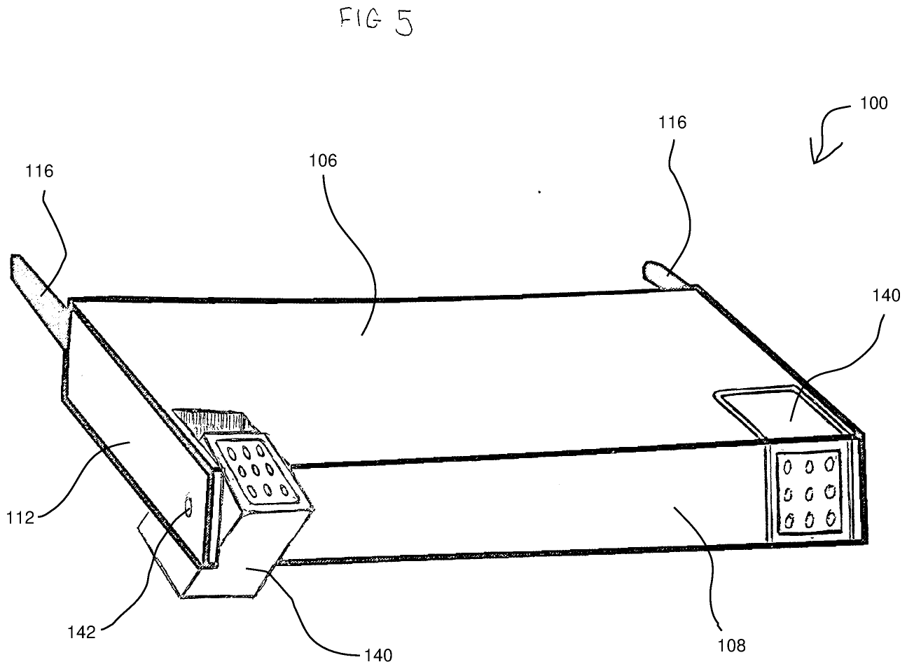

Referring to FIG. 5, the door 100 includes integrated floodlights or spotlights (generally, lights 140). In the illustrated embodiment, the lights 140 are pivotally connected to the door 100 by a pivot connection 142 in order to swivel so that the user can direct the light in a desired direction. The lights 140 can also be recessed for pop-out style or hard-mounted into position.

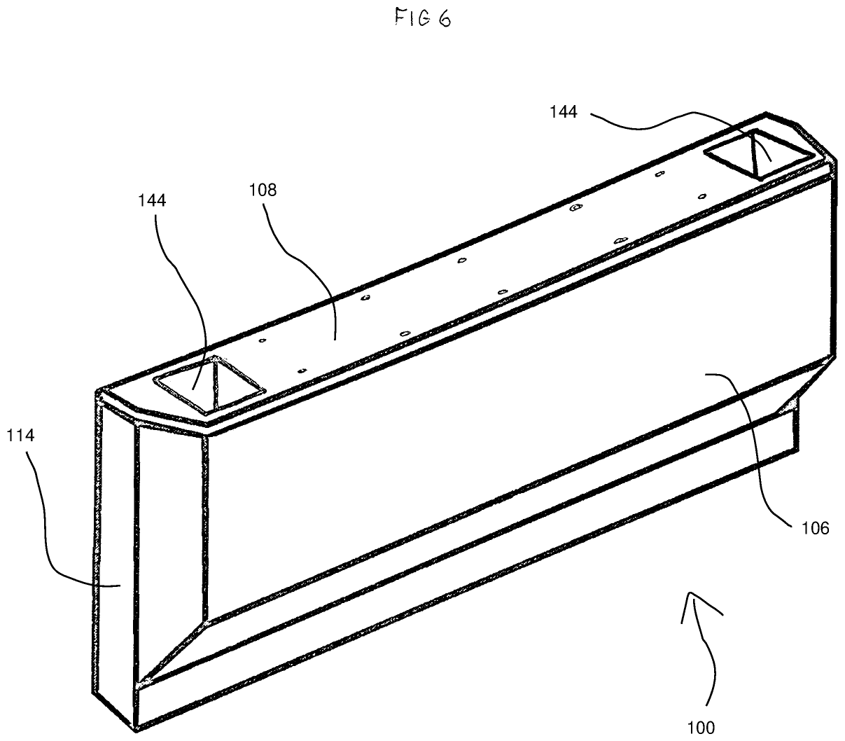

Referring to FIG. 6, the door 100 include modular attachment points 144 (e.g., holes for inserting mounts, such as roof racks, and/or openings for lights). These attachment points 144 can be done at any angle, including horizontally and vertically and on a tailgate for any vehicle, including, but not limited to, trucks, SUVs, UTVs, tractors, and trailers.

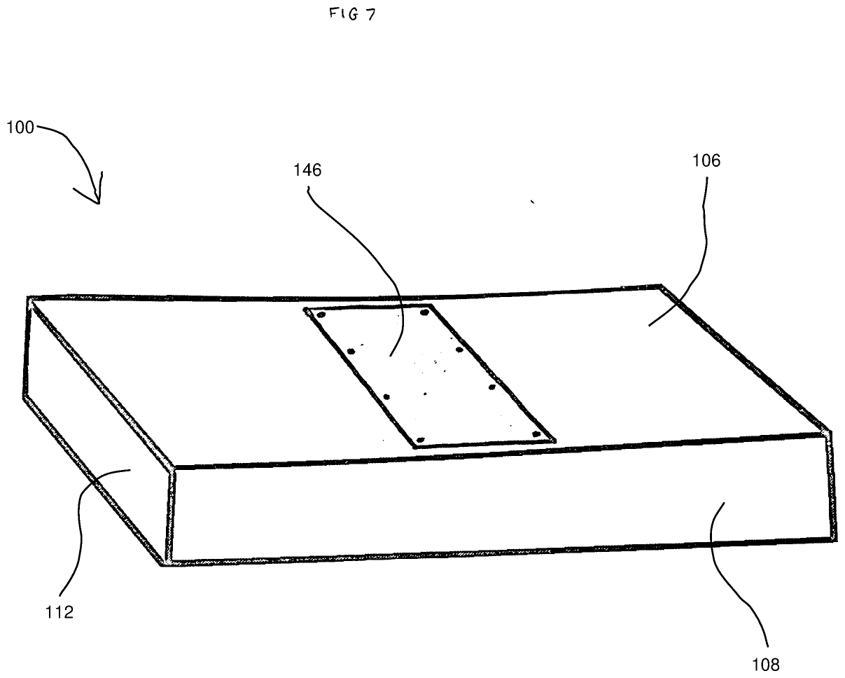

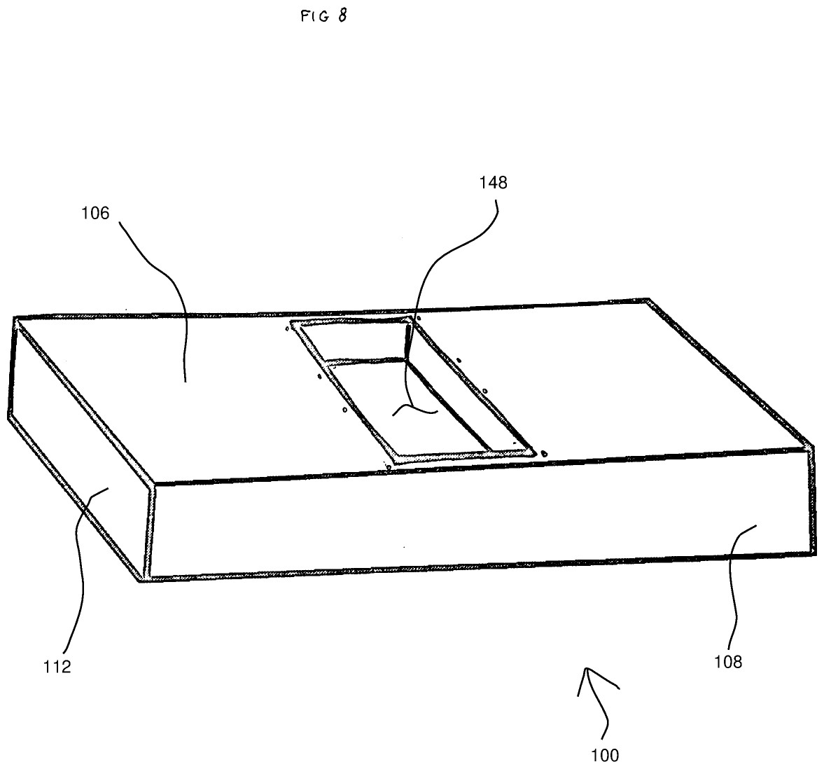

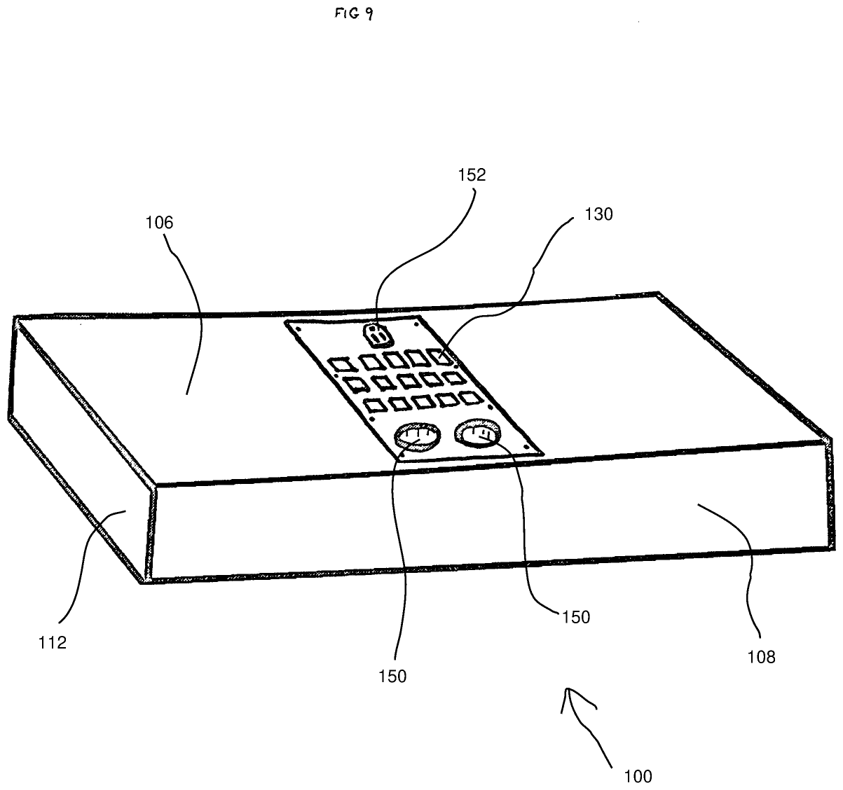

Referring to FIGS. 7 to 9, the door 100 includes a removable panel accessory 146. When removed, a storage cavity 148 is exposed. This cavity can be any size and located anywhere on the door, door, or removable top, including the front 104, back side 106, sides 112, 114, top 108, or bottom 110. It can house multiple items including, but not limited to electronics, inverters, speakers, coolers, food, drinks, personal items, motor oil, fuel cans, and tools. The attached panel can include built-in cup holders 150, a MOLLE panel system 130 for storage, an electrical outlet 152 for which the inverter can be housed behind the panel. Panels can be flat, recessed into the cavity, or protruded outward of the cavity depending on the application. They can be flush-mounted using existing mounting points on the outside of the tailgate, door, or top, or by using mounting points on the inside of the cavity.

Although specific features of various embodiments of the invention may be shown in some drawings and not in others, this is for convenience only. In accordance with the principles of the invention, any feature of a drawing may be referenced and/or claimed in combination with any feature of any other drawing.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

1. A vehicular tailgate, door, and/or removable top with storage, mounting, and separate use capacity comprising:
a base; and
a cavity within the base and/or mounting points on the exterior of the base.

2. A vehicular door with storage capabilities, the door comprising:
a door, the door including a front side, a back side, a top, a bottom, a left side, a right side, and a mounting member;
one or more cavities, the cavities configured to support or store items.

3. A vehicular door as set forth in claim 2, wherein the cavity comprises a drawer, the drawer being configured to project out of the left side of the door.

4. A vehicular door as set forth in claim 2, wherein the cavity comprises a drawer, the drawer being configured to project out of the right side of the door.

5. A vehicular door as set forth in claim 2, wherein the plurality of cavities comprises a plurality of mounting points, the mounting points configured to support items.

6. A vehicular door as set forth in claim 5, wherein the plurality of mounting points comprises a peg board, the peg board configured to receive pegs or hooks for supporting items.

7. A vehicular door as set forth in claim 5, wherein the plurality of mounting points comprise a MOLLE compatible mounting rack configured for supporting items.

8. A vehicular door as set forth in claim 7, wherein the MOLLE compatible mounting rack is configured to supports brackets.

9. A vehicular door as set forth in claim 5, wherein the plurality of mounting points comprise a MOLLE panel configured for supporting items.

10. A vehicular door as set forth in claim 2, wherein the door is configured to a panel, the panel overlaying the cavity on the back side of the door.

11. A vehicular door with mounting capabilities, the door comprising:
a door, the door including a front side, a back side, a top, a bottom, a left side, a right side, and a mounting member;
one or more modular attachment points configured to mount external structures.

12. A vehicular door as set forth in claim 11, wherein the modular attachment point comprising a light.

13. A vehicular door as set forth in claim 11, wherein the modular attachment point is configured to support a roof rack.

14. A vehicular door as set forth in claim 11, wherein the modular attachment points are configured to be angled at a variety of angles, including horizontal or vertical.
